(19) United States
(12) Patent Application Publication
(10) Pub. No.: US 2004/0199643 A1
(43) Pub. Date: Oct. 7, 2004

(54) Distributed service component systems

(76) Inventors: Simon G Thompson, Ipswich (GB); Thomas J Stark, Chelmsford (GB)

Correspondence Address: NIXON & VANDERHYE, PC, 1100 N GLEBE ROAD, 8TH FLOOR, ARLINGTON, VA, 22201-4714, US

(21) Appl. No.: 10/486,987

(22) PCT Filed: Sep. 6, 2002
(86) PCT No.: PCT/GB02/04091

(30) Foreign Application Priority Data
Sep. 10, 2001 (EP) 01307688.0
Sep. 10, 2001 (EP) 01307689.8

(51) Int. Cl. G06F 15/16

(52) U.S. Cl. 709/227

(57) ABSTRACT

A method of enabling collaboration between software components distributed across a plurality of data processing resources connected by a data processing network, said software components including service components (32) capable of collaborating to perform tasks and management components (34, 36, 38) for supporting collaboration of the service components, wherein said service components are capable of collaborating across a plurality of service platforms, each said service platform comprising a plurality of service components and a platform management component for controlling the registration of service components in the service platform, a component on a service platform being identifiable by at least one network address, said method comprising: transmitting a query from a first service platform to a second service platform, said query requesting identification of one or more further service platforms; and receiving a response from said first service platform, said response including data defining a network address of a third service platform.

This invention relates to distributed service component systems, in particular to such systems wherein service components are distributed across multiple service platforms. The invention relates particularly, but not exclusively, to such systems where the service components are in the form of collaborative software agents.

Software agent systems have been known for some time. An example of such a software agent system is the ZEUS project, see for example “ZEUS: A Toolkit for Building Distributed Multi-Agent Systems”, Hyacinth S. Nwana et al., Applied Research and Technology, BT Laboratories, Martlesham Heath. The ZEUS project defines a multi-agent system design approach and supports it with a visual environment for capturing user specification of agents that are used to generate Java™ source code for the agents. The agents are software components which collaborate in order to perform tasks, and may be distributed over a number of different physical data processing components and networks.

According to known models, agent systems are divided into different agent platforms, which are each under the control of a different agent platform administrator. Each agent platform is capable of controlling the identity of the agents which operate within its context, and to control the manner in which agents within one platform interwork with agents of different platforms.

Specifications for agent platform models and interworking between different agent platforms have been developed by the Foundation for Intelligent Physical Agents (FIPA).

There are several web services that have been configured in accordance with such an agent-based architecture. For example, Loryman et al, in “The Cameleon VAB service enabled by a FIPA agent platform” 2^{nd} Int ACTS workshop, 1999-09, pages 1-13, describe an agent-based system that creates, manages and provides access to address books that are distributed in a network environment (in client devices). These address books store, for example, the addresses of colleagues and business contacts, on behalf of a user. The VAB system is specifically concerned with cascading address book updates to all VAB users. The description of the VAB system concentrates on how the system works within a single agent platform; however, it does mention the possibility of distributing VAB clients over a plurality of platforms. In such a configuration, a problem of platform identification arises.

Specifically, a problem with a multi-platform system is the opening of communication channels between the different platforms of the system. For example, if a new platform joins the system, a problem is how other platforms begin interworking with it. One proposed solution is to publish the platform identities, including network addresses at which components of a platform may be contacted, on a central Web server, for example one managed by FIPA. The site contents would be updated manually by a human administrator, and a component of a platform may thus identify other platforms, and the services they offer, by querying the known central server. A problem with this approach is that, as the number of platforms increase, the need for updating of the information on the site will increase and become difficult to manage. Furthermore, some platform administrators may not wish their platform details to be publicly available.

In accordance with the present invention there is provided a method of enabling collaboration between software components distributed across a plurality of data processing resources connected by a data processing network, said software components including service components capable of collaborating to perform tasks and management components for supporting collaboration of the service components, wherein said service components are capable of collaborating across a plurality of service platforms, each said service platform comprising a plurality of service components and a platform management component for controlling the registration of service components in the service platform, a component on a service platform being identifiable by at least one network address, said method comprising:

transmitting a query from a first service platform to a second service platform, said query requesting identification of one or more further service platforms; and

receiving a response from said first service platform, said response including data defining a network address of a third service platform.

Accordingly, the invention provides a mechanism whereby a platform is able to discover network addresses for as yet unidentified platforms by interaction with other platforms.

In this aspect, an agent platform is defined as a plurality of service components and a platform management component for controlling the registration of service components in the service platform, which, when the service platform operates in accordance with the FIPA standard, includes an Agent Management System, AMS, to be described in further detail below). An agent platform preferably also includes a component providing a point of contact to external entities, such as the ACC (to be described in further detail below), which is able to interact with service components of the platform directly using an internal messaging protocol. In this case, the platform address is preferably an address of the component providing the point of contact.

According to a second aspect of the invention, there is provided a method of enabling collaboration between software components distributed across a data processing system comprising a plurality of data processing resources connected by a data processing network, said software components including service components capable of collaborating to perform tasks and management components for supporting collaboration of the service components, wherein said service components are capable of collaborating across a plurality of service platforms, each said service platform comprising a plurality of service components and a platform management component for controlling the registration of service components in the service platform, a component on a service platform being identifiable by at least one network address, said method comprising:

at a first service platform, discovering a second service platform by interacting with one or more service platforms other than said second service platform;

receiving a search query from a third service platform at said first service platform, said query requesting identification of a component in the data processing system; and

transmitting a search query from said first service platform to said second service platform, said query requesting identification of said component.

Advantageously the method includes receiving a query from said third service platform at said first service platform, said query requesting data identifying one or more different service platforms. Stored platform address data is then accessed and a response, defining a network address of one or more different service platforms, is transmitted to the third service platform. Significantly, said one or more different service platforms in the response do not include said second service platform.

Preferably said stored data is accessed systematically so that the inclusion of network addresses of service platforms to which such search requests are transmitted in response to queries requesting identification of one or more different service platforms is inhibited.

Conveniently said storing comprises storing two separate sets of data defining network addresses, to be used in relation to search requests and query responses respectively.

Advantageously the method involves conducting a search in relation to service components registered with said first platform prior to transmitting said search query to said second platform, and transmitting said search query in dependence on an appropriate service component not being found in said search.

Preferably the method involves checking, on the basis of an identity of said third platform, an access permission setting prior to conducting said search, and conducting said search in dependence on an allowable access permission setting being associated with said third platform.

Preferably the method involves checking, on the basis of an identity of said third platform, an access permission setting prior to transmitting said search query to said second platform and transmitting said search query in dependence on an allowable access permission setting being associated with said third platform.

Conveniently the method involves monitoring a plurality of search requests received from said third service platform, and conducting the propagation of search queries to said second service platform in dependence on said monitoring.

Advantageously the method involves detecting a setting in said search query received from said third service platform, said setting relating to the number of times the search query is propagated between agent platforms, and conducting the propagation of the search query to said second service platform in dependence on said setting.

Preferably said first and second service platforms are not federated.

Conveniently the method includes transmitting a query to a fourth service platform, said query requesting identification of said component.

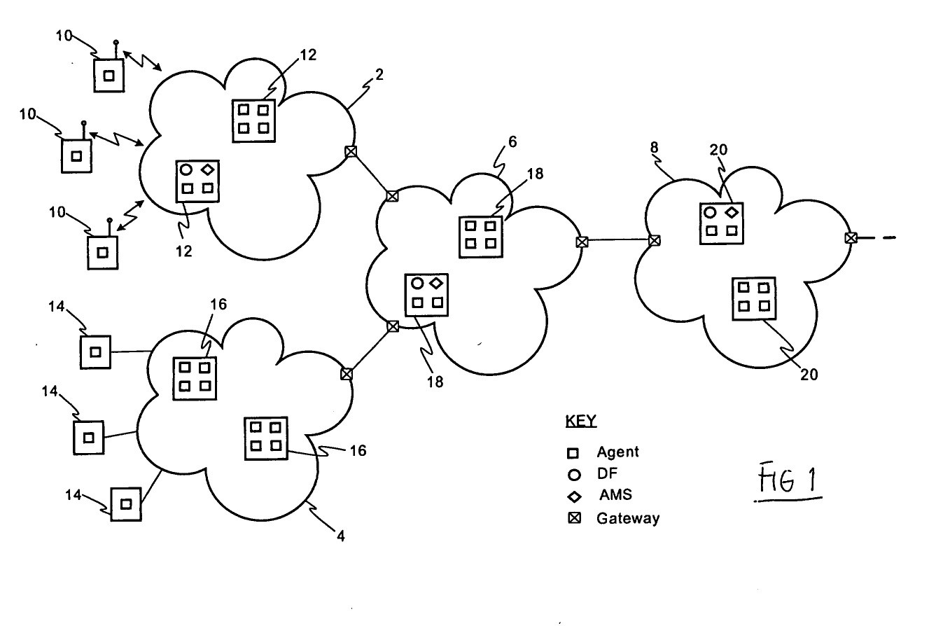

Further features and advantages of the invention will become apparent from the following description of preferred embodiments of the invention, made with reference to FIGS. 1 to 6, wherein:

FIG. 1 is a schematic illustration of an example of a network architecture used in embodiments of the invention;

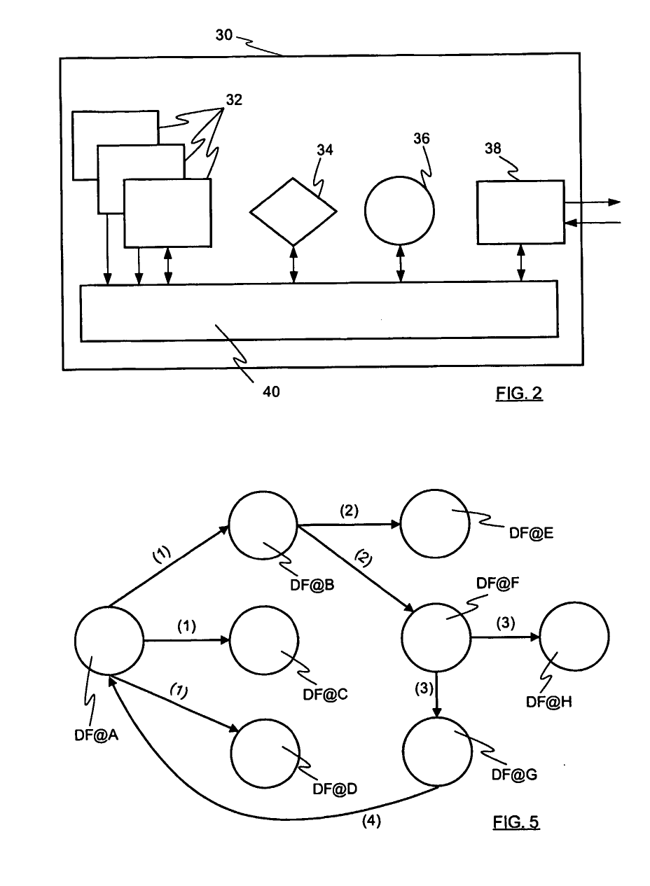

FIG. 2 is a schematic illustration of an agent platform used in accordance with an embodiment of the invention;

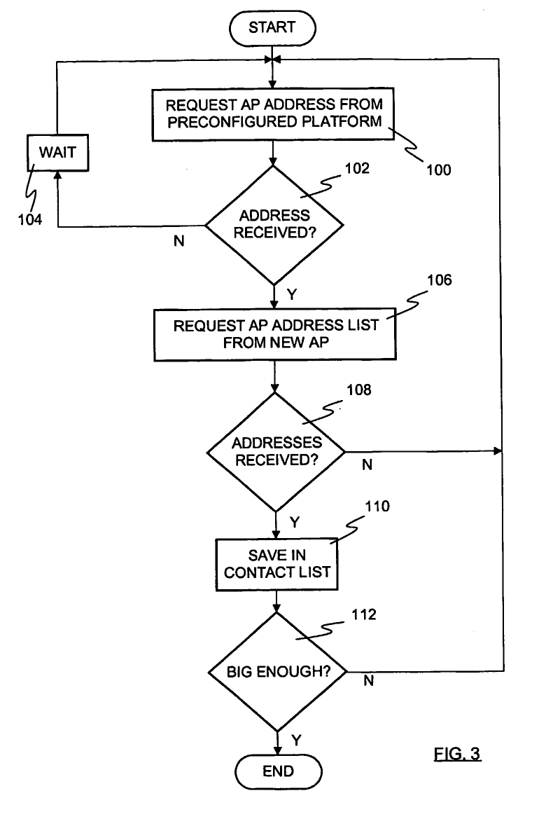

FIG. 3 is a flow diagram showing steps carried out on an agent platform;

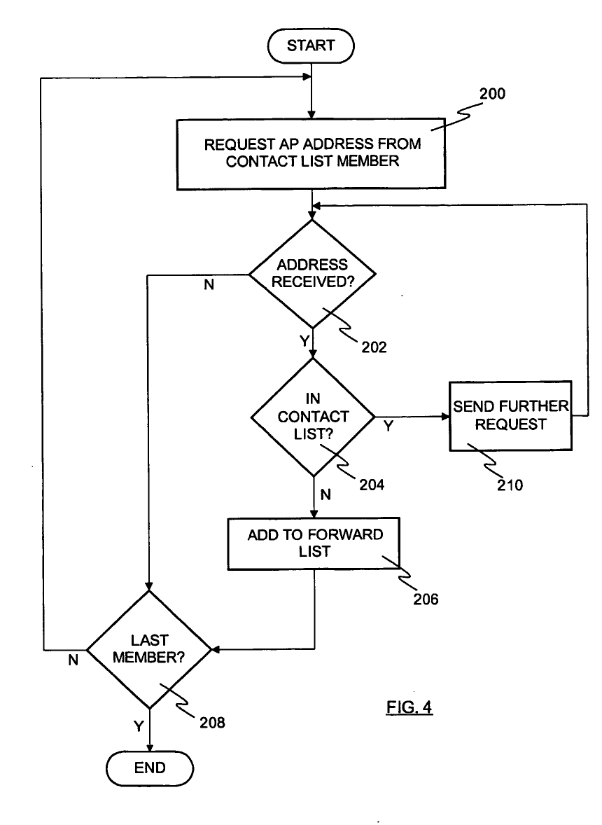

FIG. 4 is a flow diagram showing steps carried out on an agent platform;

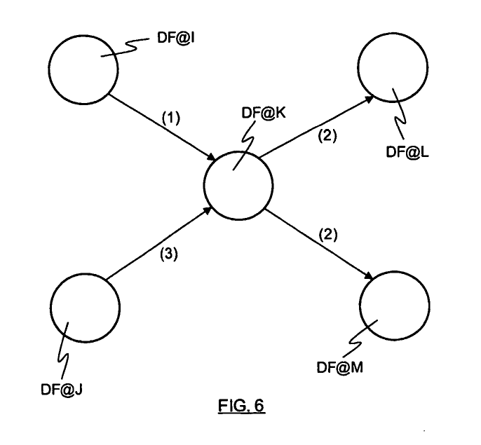

FIG. 5 is a schematic illustration showing interactions between agent platform components; and

FIG. 6 is a schematic diagram showing interactions between agent platform components.

FIG. 1 illustrates an exemplary data communications system arranged in accordance with an embodiment of the present invention. The system includes a plurality of interconnected data communications networks in the form of a public land mobile network (PLMN) 2, a public switched telephone network (PSTN) 4, a first infrastructural data communications network 6, such as an asynchronous transmission mode (ATM) network, and a second infrastructural data communications network 8, such as a synchronous digital hierarchy (SDH) network. The exemplified system includes four different networks, however the system may include fewer or a larger number of such networks and similar or varied network types, including satellite data communications networks and other types of land-based data communications networks. The networks are interconnected via gateways, such that data processing devices on any one of the networks are able to communicate with data processing devices on any other of the networks via a common network protocol, such as one or more versions of the Internet Protocol (IP) such as IPv4 and IPv6. Communicated data is usually structured according to a well known protocol such as HTTP (HyperText Transmission Protocol) or CORBA (Common Object Request Broker Architecture), but may also be transmitted using another standardised protocol or a proprietary protocol.

The PSTN 2 provides network connectivity to a number of different mobile hosts 10 via radio communications links, such as cellular radio communications links. The PSTN provides network connectivity to a number of different fixed hosts 14 via fixed line connections, such as copper wires. Each of the networks also includes network-based data processing modules, referred to herein as servers, for providing support and service functions to the network hosts. PLMN 2 includes a plurality of servers 12, PSTN 4 includes a plurality of servers 16, ATM network 6 includes a plurality of servers 18 and SDH network 8 includes a plurality of servers 20.

Each of the hosts 10, 14 and servers 12, 16, 18, 20 includes data processing functionality and includes software components that are part of a system of distributed software agents. The agents are resident on a number of separate agent platforms, each controlled by different platform administrators, together forming a distributed agent system referred to as the Agent Universe, which provide the context in which the agents operate and interwork.

In a first embodiment, each agent platform conforms to an agent platform model developed by the Foundation for Intelligent Physical Agents (FIPA), and FIG. 2 shows a model defined by FIPA for each of the multiple agent platforms illustrated in FIG. 1. Each agent platform includes a plurality of agents, at least one directory facilitator (DF) and an agent management system (AMS). As illustrated in FIG. 1, all agents resident in PLMN 2 and its mobile hosts 10 are members of a first agent platform (AP), whilst all agents resident on PSTN 4 and its fixed hosts 14 and ATM network 18 are members of a second AP, and all agents resident on SDH network 8 are members of a third AP.

An Agent Platform (AP) 30 provides the physical infrastructure in which agents can be deployed. An AP typically includes data processing device(s), operating system(s) (not shown), agent support software, agent management components (e.g. the DF 36 and AMS 34) and the agents 32 themselves. Agents exist physically on an AP and utilise the facilities offered by the AP for realising their functionalities. An agent, as a physical software process, has a physical life cycle that is managed by the AP.

The agents 32 are software components associated with an AP which provide one or more service capabilities that may include access to external software, human users and communications facilities. An agent typically has resource brokering capabilities for accessing software enabling it to offer its one or more services to other agents. Agents may access software, for example, to add new services, acquire new communications protocols, acquire new security protocols or algorithms, acquire new negotiation protocols, access tools which support migration, etc.

An agent acts on behalf of at least one owner, for example, based on organisational affiliation or human user ownership, and an agent may support several types of identity. The FIPA agent naming reference model identifies an agent through an extensible collection of parameter-value pairs, called an Agent Identifier (AID). An AID comprises a name and other parameters, such as transport addresses, name resolution service addresses, and so on. AIDs are primarily intended to be used to identify agents inside the envelope of a message, either as an originating address or a destination address. The AID labels an agent so that it may be distinguished unambiguously within the Agent Universe. The name parameter of an AID is a globally unique identifier that can be used as a unique referring expression of the agent. One exemplary naming method is to construct the name from an identity which is unique within a namespace provided by the platform with which the agent is registered, referred to as the home agent platform (HAP), and the HAP address, typically an Internet domain name, separated by the ‘@° character.

An agent may be registered at a number of transport addresses at which it can be contacted. A transport address is an address at which an agent can be contacted and is usually specific to a message transport protocol. A given agent may support many methods of communication and can put multiple transport address values in the addresses parameter of an AID.

The Agent Management System (AMS) 34 exerts supervisory control over access to and use of the AP. The AMS represents the managing authority of an AP and if the AP spans multiple data processing devices, then the AMS represents the authority across all devices. Only one AMS exists in a single AP. The AMS on an AP has a reserved name of ams@hap, where hap represents the HAP address.

The AMS maintains an index of AIDs, which contain transport addresses (amongst other things) for agents registered with the AP. The AMS offers “white pages” directory services to other agents. Each agent must register its AID with an AMS in order to be accessed via an AP (so that it can be located upon querying the AMS). The AMS is responsible for managing the creation of agents, the deletion of agents, deciding whether an agent can dynamically register with the AP and overseeing the migration of agents to-and from the AP (if agent mobility is supported by the AP). The AMS supervises the life cycle of each agent on the AP. The life of an agent with an AP terminates with its deregistration from the AMS. After deregistration, the AID of that agent can be removed by the directory and can be made available to other agents who should request it.

Name resolution is a service that is provided by the AMS through a search function through which the AID of the agent can ultimately be resolved into a transport address or set of transport address. An exemplary name resolution pattern is as follows:

1. AgentA wishes to send a message to AgentB, whose name is known from the AID, but whose transport address is unknown.

2. Therefore, AgentA sends a search request to the AMS at the platform address specified in the AID.

3. If the AMS has AgentB registered with it, then it returns a result message containing the AMS agent description of AgentB; if not, then a failed message is returned.

4. Upon receipt of the result message, AgentA can extract the transport address(es) of AgentB.

5. AgentA can now send a message to AgentB.

The Directory Facilitator (DF) 36 provides “yellow pages” directory services to other agents. Agents may register their services with the DF or query the DF to find out what services are offered by other agents. Multiple DFs may exist within an AP. The default DF on an AP has a reserved name of df@hap, where hap represents the platform address.

Each DF is able to register and deregister agents from its directory service. Every agent that wishes to publicise its services to other agents, should find an appropriate DF and request the registration of its agent description. There is no intended future commitment or obligation on the part of the registering agent implied in the act of registering. For example, an agent can refuse a request for a service which is advertised through a DF. The deregistration function has the consequence that there is no longer a commitment on behalf of the DF to broker information relating to that agent. At any time the agent may request the DF to modify its agent description.

An agent may request information from a DF by initiating a search. The DF directory search function first searches locally and then extends the search to other DFs, if allowed. DFs may register with each other to form federations. The federation of DFs for extending searches can be achieved by DFs registering with each other. A DF may however restrict access to information in its directory according to access permissions set for different agents types and identities.

Communication between agent platforms is carried out using standard protocols, such as those defined by FIPA, and requires knowledge of an agent platform address of one agent platform by another. The Agent Communication Channel (ACC) 38 is a component which uses information provided by the AMS 34 to route messages between agents within the platform and to agents resident on other agent platforms. The ACC is essentially the AP point of contact to external APs. Thus, although addresses of other components may also be used as an agent platform address, in this example the agent platform address is that of the ACC. The address of the ACC generally forms part of the Agent Platform description for FIPA-compliant APs. The AP description includes an address sequence part which includes the platform address in the form of one or more addresses of the ACC in one or more different formats, exemplified by the following:

http://271.32.108.21:8001/ACC;

corbaname:iiop:217.32.108.21:2000/NameService/ICC

In the above, the first example is an http address. The second example is one of a number of different possible formats of CORBA addresses which can be recognised by varying implementations of CORBA nameservices.

Thus the address of the ACC is used as the AP address. For example, to contact a DF of an agent platform, the requesting external component would use the address of the ACC and would include the name of the agent (in this case “DF”, for example) being contacted in a message constructed in accordance with the FIPA messaging protocols. The ACC would then forward the message using the Internal Platform Message Transport Service (IPMTS) 40.

The IPMTS 40 is used for communications between elements on the agent platform, which may use any internal communications protocols set by the AP administrator. Examples include the Sockets protocol and the TCP/IP protocol, Remote Method Invocation (RMI), the CORBA protocol or the use of object-oriented method calls.

FIG. 3 illustrates processes carried out by an agent management component of an agent platform in order to discover agent platform addresses to be added to a contact list held by the agent platform. The component may take the form of a DF, an AMS or a separate, dedicated agent management component. In the following, the component conducting the discovery processes is referred to as the platform address directory (PAD), although it is to be understood that it may in fact be a DF or AMS.

At the start of the discovery process, the PAD is preconfigured with the AP address of a different AP. The address may be preconfigured manually by an administrator entering the address into the AP via a management terminal for the AP. Alternatively, the AP address may be preconfigured by a trusted third party, for example by the posting of the AP address on a publicly accessible network resource, such as a Website, which the PAD is adapted to access on a regular basis.

In a first step 100 of the discovery process, the PAD requests a further AP address from the preconfigured platform, and waits a predetermined period in step 102, after which if no valid response is received, the PAD intermittently, between waits (step 104) repeats the procedure until a valid response is received. If a further AP address is received in step 102, the PAD configures the address as that of a preferred discovery partner and transmits a request to the newly configured AP for an AP address list, consisting of platform addresses known to the newly configured AP, step 106. The PAD then waits a predetermined period in step 108. If no valid response is received within the period, the PAD returns to step 100 to request a further AP address from the preconfigured platform. If in step 108 a list of AP addresses is received, the list is configured by the PAD as a contact list for the agent platform, step 110.

The PAD is arranged to maintain a contact list consisting of at least a preconfigured number of AP addresses, if possible. Therefore, in step 112, the PAD determines whether the number of AP addresses in the contact list is sufficient. If not, the PAD returns to step 100 in order to request a further AP address from the preconfigured platform in order to carry out the above-described procedure to add further members to the contact list. Once the contact list is deemed to be sufficient, according to the pre-stored setting in a PAD, the contact list is complete. The PAD will subsequently send a “ping” message to each member of the contact list at predetermined intervals in order to check the availability of each platform identified in the contact list. If no response is received to the “ping” message, the agent platform is deemed unavailable, and removed from the contact list. If the contact list falls below its desired size, the PAD will return to step 100 in order to discover further AP addresses to add to the contact list.

The contact list built by the PAD in the procedure illustrated in FIG. 3 is used by the agent management components of the agent platform to allow interworking between agents on the home agent platform of the PAD and agents resident on other platforms. For example, the platform's AMS or a DF may conduct a search using platform addresses provided in the contact list.

Each PAD is thus capable of building its own contact list using a procedure such as that described in relation to FIG. 3.

Each PAD is also adapted to build a further list of platform addresses, referred to herein as a “forward list”, used to assist PADs on other platforms to build their own contact lists, using a procedure such as that illustrated in FIG. 4. A PAD first selects an AP address from its contact list, and requests a further AP address, to be added to its forward list, from the PAD at the AP address selected, step 200. If within a certain period an address is received in response, step 202, the PAD will first check the AP address against the listings in its contact list. If the received AP address does not appear in the contact list, step 204, the received AP address is added to the forward list, step 206. Next, step 208, a different member of the contact list is selected and a request for a further AP address for the forward list is sent to the newly selected member, step 200, which process is continued until each member of the contact list (or each of a specified number of the contact list) has been requested for their further AP address. Once all, or the specified number of members have been contacted in this manner, the forward list is completed. If no response is received from any one of the members in step 202, the process moves to the next member of the contact list. If at any point a received AP address corresponds with one which is held in the contact list, the received AP address is discarded, step 206, and a further request for a forward list member is sent to the AP, step 210. This process ensures that the members of the forward list and the contact list remain entirely distinct (although it is preferred that there is no overlap, some overlap may occur in an alternative embodiment, however it would remains an object to maintain the two lists substantially without overlap).

Thus, the procedure of FIG. 4 is used to build a forward list. When the PAD is next contacted by a PAD on another platform and requested to provide a list of agents known to it, for example to build its own contact list or forward list, the PAD transmits its forward list, or a selected part thereof, to the requesting PAD. If the requesting PAD only requests one of, or a subset of, the forward list, the PAD will select one or more addresses from the forward list according to a rolling process whereby different members of the forward list are included in responses to subsequent such requests.

It is preferred that each of the interworking agent platforms includes a PAD having the functionality described in relation to FIGS. 3 and 4. By this functionality, the agent platform is capable of maintaining its own directory of interworking agent platforms, whilst only having been preconfigured with one, or perhaps a relatively small (compared to the entire population of APs in the Agent Universe) number of, agent platform addresses.

FIG. 5 illustrates a messaging sequence for a cross-platform search carried out by an agent management component of an agent platform, referred to here a platform A, in accordance with an embodiment of the invention. In this example, the component is the directory facilitator DF@A of agent platform A. The DF uses platform addresses from its contact list to create a dynamic federation of DFs with which to perform the search. The DF may, for example, have received a request to provide the AID of an agent capable of performing a desired service. The DF will first check its own directory of agents native to its platform, and determine whether a suitable agent is resident on its platform.

In the present example, it is assumed that the DF does not have details of a suitable agent in its own directory. Thus, neither the requesting agent nor the DF knows the AID of the agent being sought. The DF expands the search by accessing the agent platform contact list held by the PAD and transmitting a search request to each of at least some, and preferably all, DF of the agent platforms on the contact list, using the addresses appearing therein. In the example shown, the agent platforms appearing in the contact list consist of platforms B, C and D, and the first sequence of search requests, illustrated as messages (1) are sent to each of DF@B, DF@C and DF@D. The search request message includes the return address of the requesting DF, the parameters of the search request (in this case parameters relating to the service sought), and a time to live (TTL) element indicating the number of times the search request should be propagated before the search request is discarded. Each of the receiving DFs individually may determine whether or not to propagate the search request further if the agent identified is not currently within the agency of the DF itself. Indeed, even if the agent is currently within the residency of the DF itself, each DF individually may determine whether or not to respond to the search request, on the basis of access permission settings determining whether or not to accept service requests from the requesting platform and whether to propagate search requests to members of its contact list. In the example shown in FIG. 5, each of DF@C and DF@D have determined that no further action should be taken on the basis of the search request message received. On the other hand, DF@B has, on the basis of its access permission settings, searched its own directory and determined that the agent identified in the search request is not within its agency, and determined that the search request may be propagated. The time to live (TTL) of the message exceeds the current count of hops from the requesting agent platform (the TTL is set, in this example, at 3 or above). Hence, DF@B propagates the search request with a further message sequence, indicated as messages (2), to the agent platforms within its own contact list, in the example shown platforms E and F. Each of DF@E and DF@F may, optionally, search their own agent directories and, if the agent is not present within their own agency, propagate the request further. In this example DF@E does not propagate the request further, whilst DF@F propagates the request in a further message sequence, indicated as messages (3), to DFs of platforms in its contacts list, namely platforms G and H. In the example shown, a suitable agent is resident on platform G, resulting in a response sent to DF@A, indicated as message (4) which provides the AID of the agent being sought. DF@A may then pass the AID to the initially requesting agent in order for the requesting agent to format a service request to be sent to the identified agent.

FIG. 6 illustrates a further example of platform interworking, in which agents on public network agent platforms I and J are prevented from contacting agents on private network agent platforms L and M by means of a proxy agent platform K. The proxy agent platform K is present in the contact list of each of the public network agent platforms I and J, thus allowing DF@I and DF@J to transmit search requests to DF@K. In a first example, DF@I, in a first message (1), transmits an agent search request to DF@K, which determines, by means of its access permission settings, whether or not to propagate the search request to one, or both of, the private network agent platforms. In the example shown, agent platform I is trusted by agent platform K, and DF@K therefore propagates the search request, as further messages (2) to each of the DFs of the private network agent platforms L and M. However, in the case of a different public network agent platform, platform J, a search request initiated by DF@J, the message (3) is filtered out by DF@K, in accordance with its own access permission settings, for example due to an insufficient level of trust associated with agent platform J.

In the examples illustrated in FIGS. 5 and 6, the search function is carried out by interworking DFs on separate agent platforms. Similar multi-platform search procedures may also be carried out by interworking AMSs on different platforms, for example to provide name resolution services. This enables an AMS to provide a current transport address for an agent resident on an unknown platform on the basis of an agent name provided to it by a requesting agent resident on its own platform.

It is also possible to conduct multi-platform searches over other infrastructure components apart from AMSs and DFs. For example other name service resolution components such as the Zeus Nameservice agent that provide enhanced functionality or a part of the functionality provided by the AMS component. Other infrastructure components might include, but are not limited to, components providing information on the goals being persued by agents on a platform; components describing the knowledge resources of the agents on a platform; agents providing information on the data resources available on a platform; agents providing information on sensor or actuator availability on a platform; agents providing information on negotiation procedures used on a platform; agents providing information on computational effects produced by a platform; or agents providing information on ontology resolution mechanisms available from a platform.

In the examples described above, search requests may be discarded on the basis of access permission settings in a platform receiving a search request. Such access permission settings may include fixed settings, identifying platforms or sets of platforms, with which a platform is, or is not, allowed to interwork. The access permission settings may also be implemented as dynamically varying settings. For example, a platform may be configured to respond to a set number of search requests received from an internetworking platform, after which further access is denied. Furthermore, a trading mechanism may be used whereby agent platforms monitor the number of search requests received from each interworking agent platform along with the number of search requests it itself sends to the same agent platforms. An agent platform may allow up to a predetermined imbalance (measured for example in terms of a number of requests in a given period) of in the incoming and outgoing search requests sent from and to a given platform, or set of platforms, before further access is denied. Such dynamic access permissions, whilst allowing an agent platform to interwork with external agent platforms, can be used to prevent over-use of the platform's resources by external agents at the expense of availability of resources to its own agents. It could also be used by an agent platform to infer that information on the location of a service, name or sought after information should be provided to agents that repeatedly make requests for information that is then propagated by this agent platform. In this way the use made of an agent platform as a proxy or channel between two agent platforms could be regulated and the network of agent platforms could be self-organising.

The above embodiments are to be understood as illustrative examples of the invention. Although the agent platform model used in the described embodiments of the invention is generally similar to that specified by FIPA, the invention applies to agent platforms arranged in accordance with different such models. For example, embodiments of the invention would work in accordance with agent platforms corresponding to the following specifications (the list is not exhaustive):

ebXML (Electronic Business using extensible Markup Language), sponsored by UN/CEFACT and OASIS, where the functionality of the DF and AMS of the first embodiment is provided by so-called Registry Services. For more information, the reader is referred to ebXML v10.4 architecture, published by UN/CEFAT, OASIS, and available, at August 2002, from http:www.ebxml.org/specs/index.htm;

IBM's Web Services Toolkit for Dynamic e-business, where the functionality of the DF and AMS of the first embodiment is provided by registry services. For more information, the reader is referred to a paper entitled “IBM Web Services ToolKit—A showcase for emerging web services technologies”, by John Feller (of IBM), published by IBM on their website and available at August 2002 from http:\www-3.ibm.com/software/solutions/webservices/wstk-info.html.

Sun™ Open Net Environment, where the functionality of the DF and AMS of the first embodiment is provided by so-called Registry services. For more information the reader is referred to “Sun” ONE Architecture Guide”, available from Sun Microsystems™.

It is to be understood that any feature described in relation to one embodiment may also be used in other of the embodiments.

Furthermore, equivalents and modifications not described above may also be employed without departing from the scope of the invention, which is defined in the accompanying claims.

1. A method of enabling collaboration between software components distributed across a plurality of data processing resources connected by a data processing network, said software components including service components capable of collaborating to perform tasks and management components for supporting collaboration of the service components, wherein said service components are capable of collaborating across a plurality of service platforms, each said service platform comprising a plurality of service components and a platform management components for controlling the registration of service components in the service platform, a component on a service platform being identifiable by at least one network address, said method comprising:
transmitting a query from a first service platform to a second service platform, said query requesting identification of one or more further service plafforms; and
receiving a response from said first service platform, said response including data defining a network address of a third service platform.

2. A method according to claim 1, comprising transmitting a message to said third service platform using the network address defined in the response.

3. A method according to claim 2, wherein said message forms a query requesting identification of one or more yet further service platforms.

4. A method according to claim 3, comprising receiving a response from said third service platform including data defining a network address of a fourth service platform.

5. A method according to claim 4, wherein said response from the third service platform includes data defining a plurality of network addresses, including that of the fourth service platform and a fifth service platform.

6. A method according to claim 1, comprising storing data defining a plurality of service platform identifiers including network addresses of a plurality of service platforms, for use by said first service platform in supporting collaboration between service components of said first service platform and service components of different service platforms, and updating said data defining said plurality of service platform identifiers in response to receiving data defining a network address of a further service platform.

7. A method according to claim 6, comprising the step of a first service component of said first service platform requesting identification of a service component to be searched for, accessing said stored data and transmitting a search request relating to the service component to be searched for to a different service platform.

8. A method according to claim 6, comprising receiving a query from a different service platform at said first service platform, said query requesting identification of one or more different service platforms, accessing said stored data and transmitting a response defining a network address of one or more different service platforms.

9. A method according to claim 8, comprising accessing said stored data systematically so as to tend to inhibit the inclusion of network addresses of service platforms to which such search requests are transmitted in responses to queries requesting identification of one or more different service platforms.

10. A method according to claim 9, wherein said storing comprises storing two separate sets of data defining network addresses, to be used in relation to search requests and query responses respectively.

11. Computer software arranged to perform the method of claim 1.

12. Data processing apparatus arranged to perform the method of claim 1.

13. A service platform for enabling collaboration between software components distributed across a plurality of data processing resources connected by a data processing network, said software components including service components capable of collaborating to perform tasks and management components for supporting collaboration of the service components, wherein said service components are capable of collaborating across a plurality of service platforms, the service platform comprising a plurality of service components and a platform management component for controlling the registration of service components in the service platform, a component on a service platform being identifiable by at least one network address, characterised by
means arranged to transmit a query to a further service platform, said query requesting identification of one or more other service platforms; and
means arranged to receive a response from said further service platform, said response including data defining a network address of another service platform.
